(19) United States
(12) Patent Application Publication
(10) Pub. No.: US 2016/0308476 A1
(43) Pub. Date: Oct. 20, 2016

(54) HOUSEHOLD APPLIANCE WITH MULTIPLE SYNCHRONOUS MOTORS AND CONTROL CIRCUIT THEREOF

(71) Applicant: ARCELIK ANONIM SIRKETI, Istanbul (TR)

(72) Inventors: Tayyar Cagdas CIRPAN, Istanbul (TR); Latif TEZDUYAR, Istanbul (TR)

(21) Appl. No.: 15/100,334

(22) PCT Filed: Nov. 29, 2013
(86) PCT No.: PCT/EP2013/075138

§ 371 Date: May 30, 2016

(51) Int. Cl. H02P 6/04; H02P 6/26

(52) U.S. Cl. CPC H02P 6/04; H02P 6/26

(57) ABSTRACT

The present invention relates to an electrical household appliance comprising at least one synchronous electric motor (11, 12), a driver circuit capable of controlling the speed of said at least one synchronous electric motor (11, 12), said driver circuit comprising a converter that converts AC mains voltage to DC voltage, a DC link and a driver circuit inverter stage (10) that inverts the direct current received from said converter to an AC output signal such that an AC output waveform is produced from a DC power supply.

The present invention relates to an electrical household appliance having multiple synchronous motors with an improved control circuit topology.

It is well-known that a synchronous machine is an electrical machine with a rotating stator magnetic flux and a rotor flux locked therewith to rotate in the synchronous frequency. A single phase synchronous machine is considered advantageous in terms of cost-effectiveness compared to a three phase synchronous motor due to the simplicity of the electronic control circuitry. A brushless DC motor is also a kind of synchronous motor that has trapezoidal back-EMF voltage shape. So “three phase synchronous motor” statement at this invention also embraces brushless DC motor.

It is also well-known that synchronous motors are widely used in rotary household appliances and especially in dishwashers and laundry treatment appliances. For instance, washing machines may have a jet pump for spraying water jets into the rotary drum targeting at specific regions inside it, at which the laundry may tend to adhere within the same, as well as a discharge pump for discharging the water contained in the drum. Likewise, a washing and/or drying machine may have a discharge pump as well as a circulation pump for circulating a refrigerant fluid.

To this end, a synchronous motor having the advantage of cost-effectiveness on the part of power and control electronics, still requires a sophisticated speed control circuit topology in which an inverter with multiple semi-conductors, i.e. power switches such as IGBTs is present. The inverter's role is therefore to dynamically control the synchronous motor's speed for instance during starting up as well as other instances where variable speed is desirable. For instance, the speed of a water circulation motor in a washing machine needs to be decreased if the amount of water in circulation is not adequate and the pump is likely to start pumping air mixed with water. This can eventually lead to generation of an uncontrolled amount of sound to the extent that customer complaints need to be addressed.

Among others, one of the prior art disclosures in the technical field of the present invention can be referred to as CN 201507484, which defines a washing machine drainage pump, wherein sound generated by the drainage pump in the ‘semi-water and semi-gas’ phase can be naturally eliminated.

The present invention, on the other hand, provides speed control of multiple synchronous motors of an electrical household appliance so as to improve the sound generation profiles thereof. In this respect a cost-effective high-frequency inverter topology is proposed in the inverter stage of the power circuit, involving a reduced number of power switches in control of the synchronous motors.

The present invention provides a speed control circuit topology for driving synchronous motors of an electrical household appliance so as to improve the sound generation profiles thereof, as provided by the characterizing features defined in claim 1.

Primary object of the present invention is therefore to provide a speed control circuit topology for driving multiple synchronous motors of an electrical household appliance so as to improve the sound generation profiles accordingly by way of employing a limited number of switching elements.

The present invention proposes an electrical household appliance with at least one synchronous electric motor. A motor driver circuit provides speed control of the electric motor by means of respective circuit stages. A rectifier stage converts AC voltage to DC voltage and a driver circuit inverter stage inverts the direct current received to obtain a variable frequency output.

A first single-phase synchronous motor's terminals are connected to a half-bridge inverter, respectively to a neutral point between two capacitors of the inverter and to a midpoint between two power switches in series.

Further, a second synchronous electric motor, that is, a three-phase synchronous motor is fed by a three-phase voltage output of a four-switch three-phase voltage source inverter. The four-switch three-phase inverter's two output phases are connected with two inverter legs having two power switches in series and the third output is taken from the midpoint of the two capacitors of the DC link. The voltage source inverters in the form of a half-bridge inverter and a four-switch three-phase inverter are connected to the same DC link.

Accompanying drawings are given solely for the purpose of exemplifying a speed control circuit topology whose advantages over prior art were outlined above and will be explained in brief hereinafter.

The drawings are not meant to delimit the scope of protection as identified in the claims nor should they be referred to alone in an effort to interpret the scope identified in said claims without recourse to the technical disclosure in the description of the present invention.

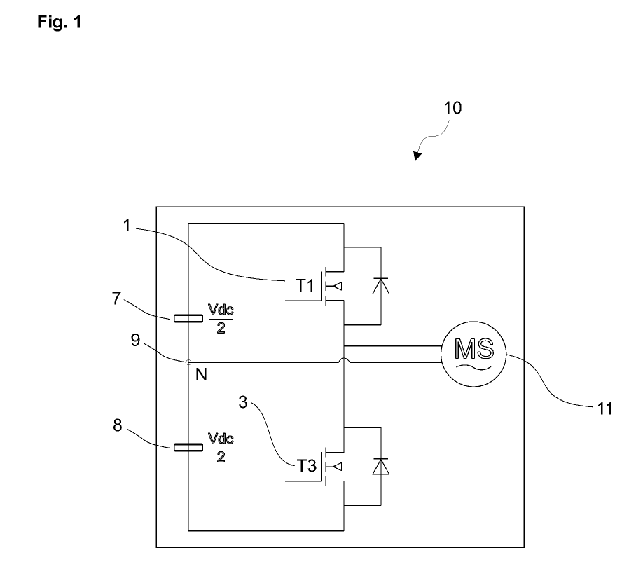

FIG. 1 demonstrates a power topology of a half-bridge voltage source inverter according to the present invention.

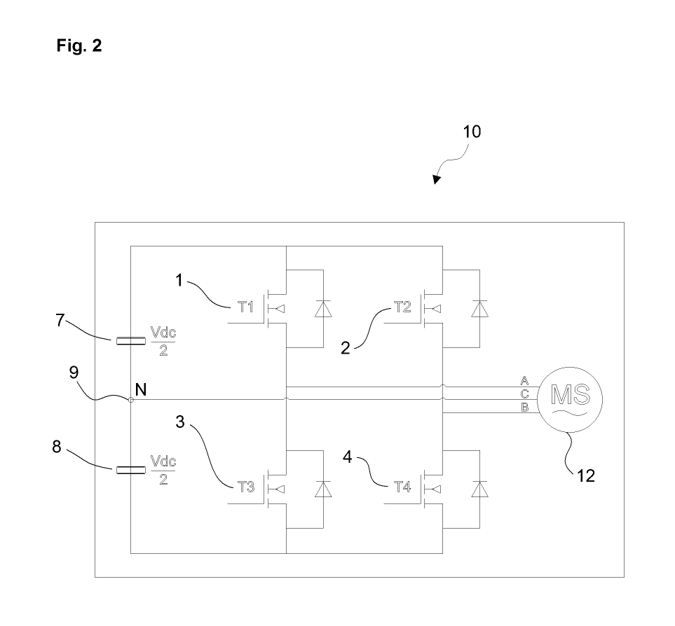

FIG. 2 demonstrates a power topology of a four-switch three-phase voltage source inverter according to the present invention.

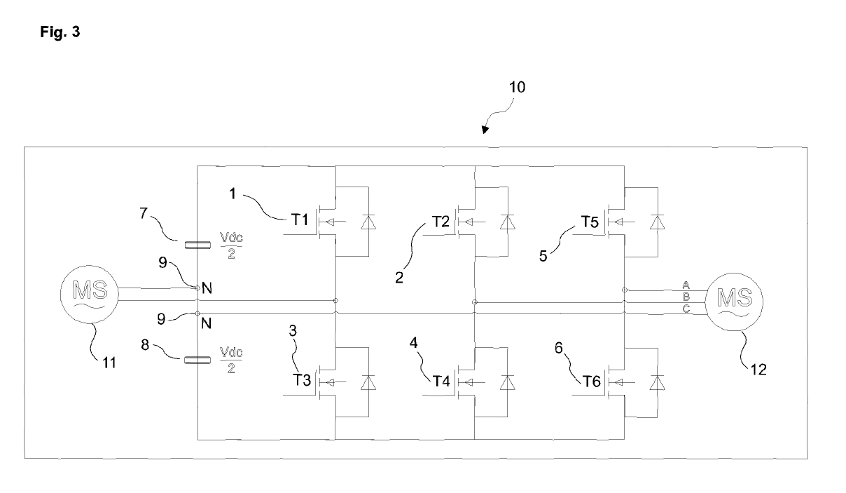

FIG. 3 demonstrates a power topology of a half-bridge voltage source inverter combined with a four-switch three-phase voltage source inverter according to the present invention.

The following numerals are used in the detailed description:
1. First power switch
2. Second power switch
3. Third power switch
4. Fourth power switch
5. Fifth power switch
6. Sixth power switch
7. First capacitor
8. Second capacitor
9. Neutral point
10. Driver circuit inverter stage
11. Synchronous electric motor
12. Second synchronous electric motor

The present invention proposes an electrical household appliance and particularly a washing machine, a dishwasher, a drying machine or a combo drying and washing machine. The electrical household appliance comprises at least one synchronous electric motor (11, 12) that could be a permanent magnet or wound rotor synchronous electric motor (11, 12) and a driver circuit that is capable of controlling the speed of said at least one synchronous electric motor (11, 12). Said synchronous electric motors (11, 12) in a household appliance could for instance be used in driving the drum and a water spraying pump in a washing machine. As another example, said synchronous electric motors (11, 12) in a household appliance could for instance be used in driving discharge pump and a circulation pump in a dishwasher. The driver circuit typically comprises a converter that converts AC mains voltage to DC voltage, a DC link and an inverter that inverts the direct current received from the converter to an AC output signal. Therefore, an AC output waveform is produced from a DC power supply. In a nutshell, the present invention proposes an electrical household appliance comprising at least one synchronous electric motor (11, 12), a driver circuit capable of controlling the speed of said at least one synchronous electric motor (11, 12), said driver circuit comprising a converter that converts AC mains voltage to DC voltage, a DC link and a driver circuit inverter stage (10) that inverts the direct current received from said converter to an AC output signal such that an AC output waveform is produced from a DC power supply.

According to the present invention, as shown in the inverter topology of FIG. 1, two capacitors (7, 8) are present to provide a neutral point N (9). A first terminal of the single-phase synchronous electric motor (11) winding is connected to the neutral point N (9) and the other terminal thereof is connected to a point in between the two power switches T1 and T3 (1, 3), the latter being connected in series. While each capacitor maintains a constant voltage (Vdc)/2, the two power switches T1 and T3 (1, 3) cannot simultaneously remain in conduction mode as a short circuit would occur across the DC link voltage source Vdc. A single-phase voltage output is therefore provided to the single-phase synchronous electric motor (11). The PWM modulation technique ensures that any one of the two power switches of the inverter is on at any given instant. In a nutshell, said at least one synchronous electric motor (11) is a single-phase synchronous electric motor (11), a first terminal of the winding of which is connected to a neutral point N (9) between two capacitors (7, 8) of the half-bridge voltage source inverter, the other terminal of the motor (11) being connected to a point in between two power switches T1 and T3 (1, 3) connected in series.

According to an embodiment of the present invention, as shown in the inverter topology of FIG. 2, a three-phase voltage output is provided to the three-phase synchronous electric motor (12), where the amplitude, phase, and frequency of the voltages is controllable. In order to avoid output voltages that will depend upon the associated line current polarity in the power inverter, the power switches of any leg of the inverter are not switched off simultaneously. In this topology, the inverter is designed to incorporate four switches T1, T2, T3 and T4 (1, 2, 3 and 4), respectively where the two output phases are directly connected with respective inverter legs, each having two power switches in series and the third output is taken from the midpoint of the two capacitors (7, 8). In a nutshell, said electrical household appliance comprises a second synchronous electric motor (12) being a three-phase synchronous motor (12) to which a three-phase voltage output is provided by said driver circuit inverter stage (10) such that the DC link of said half-bridge voltage source inverter is additionally connected with a four-switch three-phase voltage source inverter. Said four-switch three-phase voltage source inverter's two output phases are directly connected with the inverter legs and the third output is taken from the midpoint of the two capacitors (7, 8).

The Pulse Width Modulation (PWM) modulating technique is typically used to control the amount of time and the sequence used to switch the power switches on and off. The modulating technique being used in this respect is the carrier-based sinusoidal pulse width modulation such that the voltages applied to the three phases are controlled quasi-sinusoidally. As the technical character and the specific applications of the sinusoidal PWM technique, among other control possibilities and PWM techniques, is extensively known to the person skilled in the art and is subject to widespread use, no further details are provided in this respect.

The present invention therefore provides that a reduced number of semi-conductor power switches are employed to realize a power driver inverter stage capable of controlling two synchronous electric motors (11, 12). The circuit topology advantageously employs 6 power switches T1, T2, T3, T4, T5 and T6 (1, 2, 3, 4, 5 and 6) in the form of a half-bridge inverter and a four-switch three-phase inverter, both connected to the same DC link, instead of conventional topologies which would require 10 power switches to effect the same function.

1- An electrical household appliance comprising at least one synchronous electric motor (11, 12), a driver circuit capable of controlling the speed of said at least one synchronous electric motor (11, 12), said driver circuit comprising a converter that converts AC mains voltage to DC voltage, a DC link and a driver circuit inverter stage (10) that inverts the direct current received from said converter to an AC output signal such that an AC output waveform is produced from a DC power supply, characterized in that said synchronous electric motor (11) is a single-phase synchronous electric motor (11), a first terminal of the winding of which is connected to a neutral point N (9) between two capacitors (7, 8) of a half-bridge voltage source inverter, the other terminal of the synchronous electric motor (11) being connected to a point in between two power switches T1 and T3 (1, 3) connected in series.

2- An electrical household appliance as in claim 1, characterized in that said electrical household appliance comprises a second synchronous electric motor (12) being a three-phase synchronous electric motor (12) to which a three-phase voltage output is provided by said driver circuit inverter stage (10) such that the DC link of said half-bridge voltage source inverter is additionally connected with a four-switch three-phase voltage source inverter.

3- An electrical household appliance as in claim 2, characterized in that said four-switch three-phase voltage source inverter's two output phases are directly connected with the inverter legs and the third output is taken from the midpoint of the two capacitors (7, 8).

4- An electrical household appliance as in claim 2, characterized in that said half-bridge inverter and said four-switch three-phase inverter are connected to the same DC link.

5- An electrical household appliance as in claim 3, characterized in that said half-bridge inverter and said four-switch three-phase inverter are connected to the same DC link.
